(19) United States
(12) Patent Application Publication
(10) Pub. No.: US 2006/0069409 A1
(43) Pub. Date: Mar. 30, 2006

(54) Pacifier deterrent

(76) Inventor: Susan D. Morris, Charlotte, NC (US)

Correspondence Address: Schwartz Law Firm, P.C.;SouthPark Towers, Suite 530, 6100 Fairview Road, Charlotte, NC, 28210, US

(21) Appl. No.: 10/950,136

(22) Filed: Sep. 24, 2004

(51) Int. Cl. A61J 17/00

(52) U.S. Cl. 606/234

(57) ABSTRACT

A pacifier deterrent includes an artificial, flexible nipple for being sucked on by a child. A coating is applied to the nipple, and has a pungent taste adapted to wean the child of a sucking habit. A mouth guard is located at a base of the nipple, and is designed to prevent the pacifier deterrent from being sucked completely into a mouth of the child.

### TECHNICAL FIELD AND BACKGROUND OF THE INVENTION

This invention relates to a pacifier deterrent. The invention resembles a conventional child's pacifier, and is intended to wean the child of his or her sucking habit. The invention is especially applicable for use by children above the age of two, and more particularly for those children who are beginning to develop permanent teeth.

Pacifiers are commonly used to soothe and comfort fussy babies and young children. While some children will give up their pacifiers naturally by the age of four, if the sucking habit continues beyond the time when permanent teeth start to erupt, the child may develop rather serious dental and orthopaedic problems including bite problems, crooked teeth, jaw misalignment, and/or a malformed palate. The severity of the problem generally depends on frequency, intensity, duration of the child's sucking. Speech defects can also occur from malaligned teeth resulting from excessive pacifier use. If for no other reason, it is generally recommended to wean children from their dependency on pacifiers before they enter pre-school to prevent teasing.

In addition to using the present deterrent, the method of the invention advises parents to encourage their children to make their own decision to give up the pacifier. Parents are coached to make statements to their child such as, “As you get older, your pacifier will start tasting bad and that is when you should stop using it.” Children directly associate the bitter tasting deterrent of the present invention with what they believe to be a normal pacifier, thus reinforcing their own decision to break the habit. For some children only one or two uses of the present deterrent is needed. Other methods for breaking the pacifier habit, such as puncturing or cutting the nipple, are generally ineffective and often provide only a temporary solution.

### SUMMARY OF INVENTION

Therefore, it is an object of the invention to provide a pacifier deterrent adapted for weaning a child of his or her sucking habit.

It is another object of the invention to provide a pacifier deterrent which resembles a conventional pacifier.

It is another object of the invention to provide pacifier deterrent which is perfectly safe for children.

It is another object of the invention to provide a pacifier deterrent which includes a bitter tasting nipple coating that contains no ingredients to cause nausea or upset the stomach.

It is another object of the invention to provide a pacifier deterrent which effectively breaks the child's pacifier habit with only a few uses.

It is another object of the invention to provide a method for weaning a child of a sucking habit.

These and other objects of the present invention are achieved in the preferred embodiments disclosed below by providing a pacifier deterrent including an artificial, flexible nipple for being sucked on by a child. A coating is applied to the nipple, and has a pungent taste adapted to wean the child of a sucking habit. A mouth guard is located at a base of the nipple, and is designed to prevent the pacifier deterrent from being sucked completely into a mouth of the child.

According to another preferred embodiment of the invention, the coating includes a vegetable ingredient.

Preferably, the vegetable ingredient is cayenne pepper extract.

According to another preferred embodiment of the invention, the coating further includes citric acid.

According to another preferred embodiment of the invention, the coating covers an entire outer surface of the nipple.

According to another preferred embodiment of the invention, a handle ring is attached to the mouth guard.

In another embodiment, the invention is a method for weaning a child of a sucking habit. The method includes the step of applying a pungent coating to an artificial, flexible nipple of a pacifier adapted to be sucked on by the child.

### BRIEF DESCRIPTION OF THE DRAWINGS

Some of the objects of the invention have been set forth above. Other objects and advantages of the invention will appear as the description proceeds when taken in conjunction with the following drawings, in which:

FIG. 1 is a perspective view of a pacifier deterrent according to one preferred embodiment of the present invention; and

FIG. 2 is a fragmentary cross-sectional view of the pacifier deterrent.

### DESCRIPTION OF THE PREFERRED EMBODIMENT AND BEST MODE

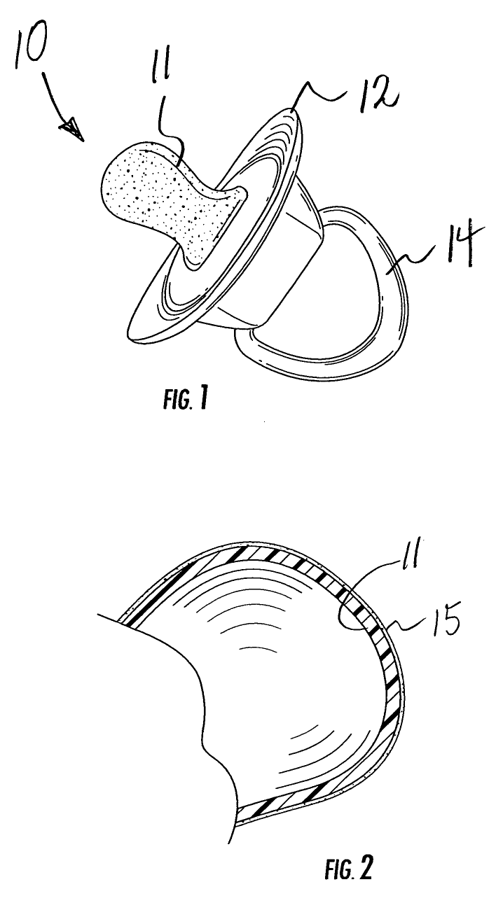

Referring now specifically to the drawings, a pacifier deterrent according to the present invention is illustrated in FIG. 1, and shown generally at reference numeral 10. The pacifier deterrent 10 is especially applicable for young children above the age of two, and particularly for those ages 4-6 when permanent teeth begin to develop. The pacifier deterrent 10 closely resembles a conventional pacifier and includes a flexible, artificial nipple 11, a plastic mouth guard 12, and a handle ring 14. The nipple 11 is permanently attached to an inside face of the mouth guard 12, and is formed of a latex rubber or silicone material. As prescribed by U.S. federal guidelines, 16 C.F.R. Part 1511, the mouth guard 12 is sufficiently large to prevent complete insertion of the deterrent 10 into the mouth of the child. The pacifier deterrent 10 meets all other specifications and requirements of these federal guidelines incorporated herein by this reference.

As best illustrated in FIG. 2, the pacifier nipple 11 has a pungent, bitter tasting outer coating 15 designed to wean the child of his or her sucking habit. Preferably, the coating 15 is applied in a liquid state to the entire outer surface of the nipple, and allowed to dry prior to packaging and shipment. The coating 15 will remain on the nipple 11 even after several days of use by the child. In an alternative embodiment, the coating 15 is applied to the pacifier nipple 11 by the consumer after purchase. As the child places the deterrent 10 into the mouth, the bitter tasting nipple 11 effects an immediate desire to remove the deterrent 10 and discontinue its use. The child associates the deterrent 10 with a conventional pacifier, and is coached to make his or her own decision to break the pacifier habit.

According to one embodiment, the nipple coating 15 comprises a bitter tasting, but harmless pure vegetable product such as cayenne pepper extract. Other ingredients may include citric acid, and certain inactive ingredients such as isopropyl alcohol, acetone, and lacquer. The nipple coating 15 contains no ingredients which are likely to cause nausea or upset the stomach. An example of one commercial product used to deter thumb sucking is sold under the trademark THUM® owned by Numark, Inc. of New Jersey. This same product may be applicable in manufacturing the present pacifier deterrent 10. Other commercial products used to deter thumb sucking and/or nail biting include MAVALA Stop™ and ORLY No Bite®. Both products contain bitter tasting but harmless ingredients. The MAVALA product contains Ethyl Acetate, Alcohol Denat., PVM/MA Copolymer, Phthalic Anhydride/Trimellitic Anhydride/Glycols Copolymer, Butyl Acetate, Acetyl Tributyl Citrate, Sucrose Octaacetate, Denatonium Benzoate, Isopropyl Alcohol, Benzophenone-1, D&C Violet No. 2. The ORLY product contains MEK, Isopropyl Alcohol, n-butyl Alcohol, Alcohol Denat, Toluene, Cellulose Acetate Propionate, Nitrocellulose, Butyl Acetate, Dibutyl Phthalate, Tosylamide/Formaldehyde Resin, Camphor, Benzophenone-1, Denatonium Benzoate, D &C Red # 17 (CI 26100). Each of these commercial products may also be applicable in manufacturing the present deterrent 10.

In an alternative embodiment, the pacifier deterrent comprises either a coated or uncoated artificial nipple, and a mouth guard with a pungent-scented inside face. The foul scent is preferably produced from natural ingredients, such as garlic and other herbs, incorporated into the molded plastic mouth guard during the manufacturing process. The scent is sufficiently strong to discourage continued use of the deterrent, and other conventional pacifiers.

A pacifier deterrent is described above. Various details of the invention may be changed without departing from its scope. Furthermore, the foregoing description of the preferred embodiment of the invention and best mode for practicing the invention are provided for the purpose of illustration only and not for the purpose of limitation—the invention being defined by the claims.

I claim:

1. A pacifier deterrent, comprising:
an artificial, flexible nipple for being sucked on by a child;
a coating applied to said nipple, and having a pungent taste adapted to wean the child of a sucking habit; and
a mouth guard located at a base of said nipple, and designed to prevent said pacifier deterrent from being sucked completely into a mouth of the child.

2. A pacifier deterrent according to claim 1, wherein said coating comprises a vegetable ingredient.

3. A pacifier deterrent according to claim 2, wherein said vegetable ingredient comprises cayenne pepper extract.

4. A pacifier deterrent according to claim 3, wherein said coating further comprises citric acid.

5. A pacifier deterrent according to claim 1, wherein said coating covers an entire outer surface of said nipple.

6. A pacifier deterrent according to claim 1, and comprising a handle ring attached to said mouth guard.

7. A method for weaning a child of a sucking habit comprising the step of applying a pungent coating to an artificial, flexible nipple of a pacifier adapted to be sucked on by the child.

8. A method according to claim 7, wherein the coating comprises cayenne pepper extract.

9. A method according to claim 8, wherein the coating further comprises citric acid.

10. A method according to claim 7, wherein the coating covers an entire outer surface of the nipple.
